(19) United States
(12) Patent Application Publication
(10) Pub. No.: US 2013/0328229 A1
(43) Pub. Date: Dec. 12, 2013

(54) PROCESS AND DEVICE FOR PRODUCING AN INJECTION MOULDING

(71) Applicants: Thomas Helming, Shanghai (CN); Markus Liedel, Waltham, MA (US)

(72) Inventors: Thomas Helming, Shanghai (CN); Markus Liedel, Waltham, MA (US)

(73) Assignee: ROBERT BOSCH GMBH, Stuttgart (DE)

(21) Appl. No.: 13/813,911

(22) PCT Filed: Jun. 21, 2011
(86) PCT No.: PCT/EP2011/060301

§ 371 Date: Aug. 21, 2013

(30) Foreign Application Priority Data
Aug. 2, 2010 (DE) 102010038765.7

(51) Int. Cl. B29C 45/00

(52) U.S. Cl. CPC B29C 45/0053
USPC 264/41; 425/4 R

(57) ABSTRACT

A process is described for producing an injection moulding (300) with the aid of an injection moulding device (100), where a charge (301) is injected into a cavity (200) of the injection moulding device (100) and is foamed with the aid of a ventilation cycle (132, 142, 152). In this process, a displacer element (130, 140, 150) restricted to a selected section (220, 240, 260) of the cavity (200) is introduced into the cavity (200), and the charge (301) is injected into the cavity (200) with the displacer element (130, 140, 150) arranged therein. In a subsequent ventilation cycle (132, 142, 152), the displacer element (130, 140, 150) is then moved out from the cavity (200) in order to foam the charge (301) in the selected section (220, 240, 260) of the cavity (200).

### BACKGROUND OF THE INVENTION

The invention relates to a method for producing an injection molding, in which a locally limited section of the injection molding is foamed selectively. The invention furthermore relates to a device for producing an injection molding of this kind

In an injection molding process, a free-flowing compound is injected into an injection mold serving as a casting mold. An injection mold of this kind typically comprises a plurality of shell parts which surround an inner mold hollow (cavity). The filling compound injected into the cavity, typically via an injection channel, is removed from the injection mold after the solidification of the material by means of an opening stroke of a shell part of the device. In the conventional injection molding method, the volume of the cavity provided by the mold is held constant up to the time of component removal, although foaming of the filling material can be achieved even in this conventional method by adding a blowing agent. For foaming wide-area structures, e.g. motor vehicle dashboards or motor vehicle door modules, a “core-back method” can then be used, in which the filling material, after complete or partial filling of the cavity, the spatial volume of the cavity is enlarged by means of an expansion stroke of one part of the mold in order to bring about foaming of the filling compound. The expansion stroke is brought about by a defined opening stroke, during which the respective mold half is opened by a defined distance, which does not yet expose the cavity.

After the solidification of the filling compound, the corresponding part of the mold is opened completely and the component is removed. With the aid of this core-back method, it is possible to produce components with very high degrees of foaming and with substantially defined edge zone thickness, making it possible to achieve an advantageous reduction in the weight of the component and the use of material.

However, the utility of the core-back method comes up against its limits as soon as the component has a geometrically challenging external geometry (e.g. a gearwheel) or contains a plurality of openings (e.g. engine cooling shroud). In this method, each component edge geometry or component opening perpendicular to the opening stroke gives rise to a high outlay in the production of the mold since the edge geometries in the core-back method each have to be reproduced in both mold halves and the mold halves must provide an accurately toleranced seal with respect to one another for the entire expansion stroke in order to prevent overpacking

This method is therefore used essentially only for geometrically simple components of wide-area design, preferably having few openings or none, such as dashboards or door modules. Moreover, the expansion stroke technique in the conventional core-back method does not allow the production of components with component areas that are locally thin-walled transversely to the direction of the stroke of the mold halves and which are smaller than the distance which the mold travels during the expansion stroke. It is therefore not feasible, for example, to produce engine cooling fans which have thin-walled component areas for aerodynamic reasons (efficiency) using the conventional core-back method.

### SUMMARY OF THE INVENTION

It is therefore the object of the invention to simplify the production of foamed components with complex component boundary geometries or thin-walled component regions.

According to the invention, a method for producing an injection molding with the aid of an injection molding device, wherein a filling compound is injected into a cavity of the injection molding device and is foamed with the aid of an expansion stroke. In this process, a displacer element limited to a selected section of the cavity is introduced into the cavity, and the filling compound is injected into the cavity with the displacer element arranged therein. In a subsequent expansion stroke, the displacer element is moved out from the cavity in order to foam the filling compound in the selected section of the cavity. With the aid of the expansion stroke locally limited to a particular section of the cavity, it is possible to foam even components with complex shapes. In particular, it is also possible to foam components with thin-walled sections, even without the expenditure on tooling which is normally necessary for this purpose.

In an advantageous embodiment, provision is made for the expansion stroke of the displacer element in the selected section of the cavity to produce a higher degree of foaming of the filling compound than in an adjacent section of the cavity. The different degrees of foaming allow a greater flexibility in the design of the components. Moreover, it is possible selectively to save weight and component material by means of selected sections with higher degrees of foaming.

Another advantageous embodiment envisages that the expansion stroke of the displacer element produces foaming of the filling compound which is limited substantially to the selected section of the cavity. This allows even greater flexibility in the design of the components.

In another advantageous embodiment, it is envisaged that filling compound continues to be injected into the adjacent section of the cavity during the expansion stroke of the displacer element in order to produce a low degree of foaming in this section. It is thereby possible selectively to keep the density high in particular component sections in order to make said component sections capable of bearing higher mechanical loads, for example.

In another advantageous embodiment, provision is made for the expansion stroke of the displacer element to produce a substantially uniform degree of foaming of the filling compound in the entire cavity. This allows foaming of regions or sections of the cavity which can be foamed only with a large amount of technical effort, if at all, by conventional methods, owing to the geometry of said cavity.

Another advantageous embodiment envisages that the expansion stroke of the displacer element is limited to the thick-walled section of the cavity, whereas no expansion stroke takes place in an adjacent, thin-walled section of the cavity. It is advantageous to limit the expansion stroke to a thick-walled section of the cavity, in particular if thin-walled regions, the thickness of which is less than the expansion stroke, are being produced.

In another advantageous embodiment, provision is made for a first displacer element, which is limited to a first selected section of the cavity, and a second displacer element, which is limited to a second selected section of the cavity, to be introduced into the cavity, wherein the filling compound is injected into the cavity with the displacer elements arranged therein. In this case, the displacer elements are moved out from the cavity simultaneously or in succession during the subsequent expansion stroke in order to foam the filling compound in the selected sections of the cavity. By using a plurality of displacer elements, it is also easy to produce relatively complex components. Here, the displacer elements do not have to have the same stroke direction. If, as is the case in a further embodiment, the displacer elements are moved out from the cavity in succession during the subsequent expansion stroke in such a way that the filling compound in the selected sections of the cavity is foamed to different degrees, this opens up the possibility of producing even very complicated components.

According to the invention, a device for producing an injection molding is furthermore provided, comprising a cavity formed from shell parts. In this case, at least one displacer element is provided, which is designed in such a way that it can be plunged into the cavity in a region limited to a selected section of the cavity. A mold of this kind is significantly easier to produce than a conventional mold for the production of components of complex construction.

In an advantageous embodiment, it is envisaged that the displacer element is arranged so as to be movable between at least one extended position, in which at least one part of the displacer element plunges into the cavity, and an end position in which one surface of the displacer element forms a boundary of the cavity. The use of a plurality of extended positions makes it possible to vary the degree of foaming.

In another advantageous embodiment, it is envisaged that the displacer element is designed as a piston that can be plunged into the cavity. Such components of the mold are particularly easy to produce.

In another advantageous embodiment, it is envisaged that the displacer element is integrated into one of the shell parts. This enables the mold to be used easily. By actuating the displacer element integrated into a shell part, it is furthermore easier to remove the finished component from the corresponding shell part after the opening of the mold.

Another advantageous embodiment envisages that the movable element is arranged between two shell parts. This embodiment enables the mold to be produced more easily.

In another modification, it is envisaged that a locking mechanism is provided for fixing the movable element in the first position thereof. This makes it possible to dispense with a drive for the expansion stroke. This, in turn, allows a simple mold construction.

Finally, another modification envisages that the locking mechanism is designed as a locking bar element that can be moved orthogonally to the expansion stroke. A locking bar element of this kind represents a particularly simple locking mechanism.

### BRIEF DESCRIPTION OF THE DRAWINGS

The invention is described in greater detail below with reference to drawings, in which:

FIG. 1 to FIG. 5 show a method according to the invention for producing a foamed component with thin-walled edge zones;

FIG. 6 shows a modification of the production method according to the invention shown in FIGS. 1 to 5, in which a component with locally limited foaming is produced;

FIGS. 7 to 10 show the production method according to the invention, in which a complex component with foamed thick-walled sections and unfoamed thin-walled sections is produced with the aid of a mold according to the invention comprising two expansion mechanisms;

FIGS. 11 to 15 show a production method according to the invention for a component, in which a gradually increasing degree of foaming of the component is produced with the aid of a mold comprising a total of three expansion mechanisms; and

FIGS. 17 and 18 show a modification of the production method according to the invention in FIGS. 11 to 16, in which foaming is accomplished with the aid of a automatically by release of the expansion mechanisms with the aid of a locking mechanism.

### DETAILED DESCRIPTION

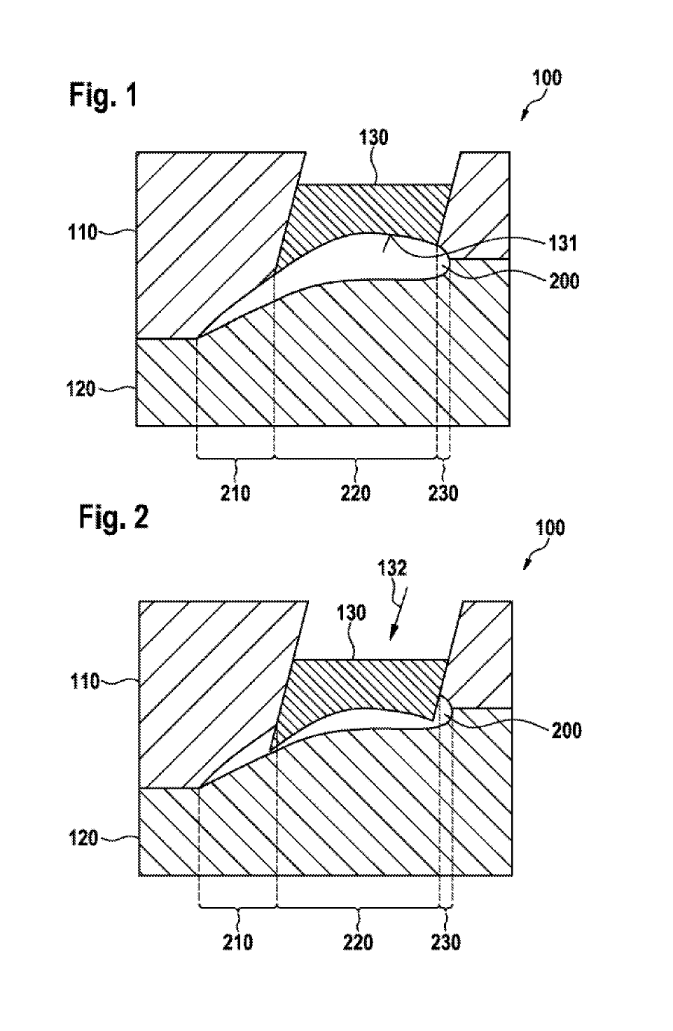

FIG. 1 shows a mold 100 according to the invention for producing a foamed component. The injection mold 100 comprises two shell parts 110, 120, which are joined together and enclose an inner cavity 200. In the illustrative embodiment under consideration, the cavity 200, which mirrors the shape of the component to be produced, corresponds to an aerodynamically shaped blade of a fan. In this case, the two mold parts 110, 120 are configured in such a way that the finished component can be removed from the mold 111 by means of an opening stroke of one of the two mold halves 110, 120. In the illustrative embodiment under consideration, the upper shell part 110 has an expansion mechanism 130 for carrying out an expansion stroke according to the invention. Here, the expansion mechanism is designed as a ram-shaped sliding element 130 which, according to the invention, is limited to a partial section 220 of the cavity 200. The lower surface 131 of the sliding element 130, which delimits the cavity 200, is shaped to match the required component geometry. In a first step of the method according to the invention, the volume of the cavity 200 is reduced by introducing the sliding element 130. As shown in FIG. 2, this can be accomplished by means of a movement 132 of the sliding element 130 into the cavity 200. During this process, the sliding element 130 plunges to a predetermined depth into the cavity 200. In the present case, the reduction in the volume of the cavity 200 which is achieved in this process is limited substantially to the central section 220 of the cavity 200.

In a subsequent method step, a free-flowing compound, generally a suitable plastic, is injected into the cavity 200 of reduced volume. The fluid plastic compound 301 is typically fed in via at least one feed channel. The feed channel, which is not shown here, can open into one of the edge sections 210, 230 of the cavity 200, for example. The filling compound 301 can fill the cavity 200 of reduced volume completely, as is the case here, or only partially.

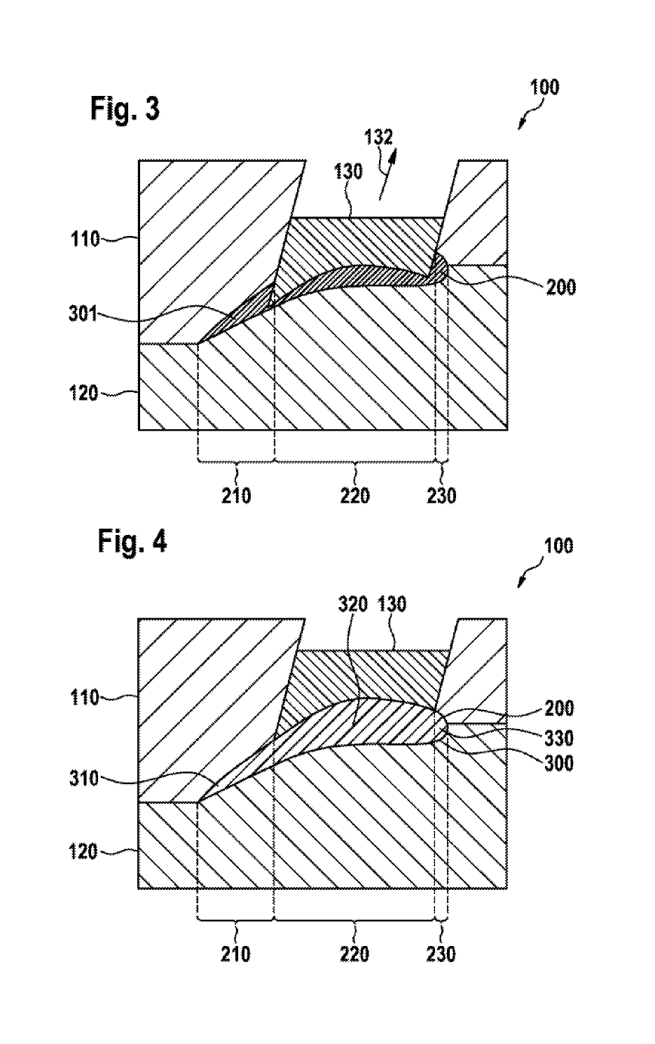

In the following method step, the preform formed by the injected filling compound 301 is foamed by means of an expansion stroke 132 of the slide mechanism 130. For this purpose, the slide mechanism 130 can be pulled out of the cavity 200 up to an end position, as illustrated in FIG. 3. As an alternative, the expansion stroke can also be achieved passively, wherein the sliding element 300 is pushed out of the cavity 200 up to the defined end position by the pressure of a blowing agent added to the plastic material 101 beforehand. Depending on the use, a combination of methods can be employed, wherein the sliding element 230 is removed from the cavity 200 both by an added blowing agent and by being actively pulled out.

As shown in FIG. 4, foaming of the filling compound 301 in the entire cavity 200 has been brought about by the expansion stroke of the sliding element 130. In the illustrative embodiment under consideration, the foamed component 300 exhibits substantially homogeneous foaming. In particular, the left hand edge section 310, which is of thin-walled design and therefore could not be produced in the conventional core-back method, also exhibits a uniform degree of foaming. After the filling compound has hardened, the finished component 300 is removed from the mold 100. For this purpose, one or both mold parts 110, 120 are moved back by means of an opening stroke in order to release the finished component 300. During this process, the finished component 300 can be pushed out of the upper mold shell 110 by means of an assisting stroke by the sliding element 130.

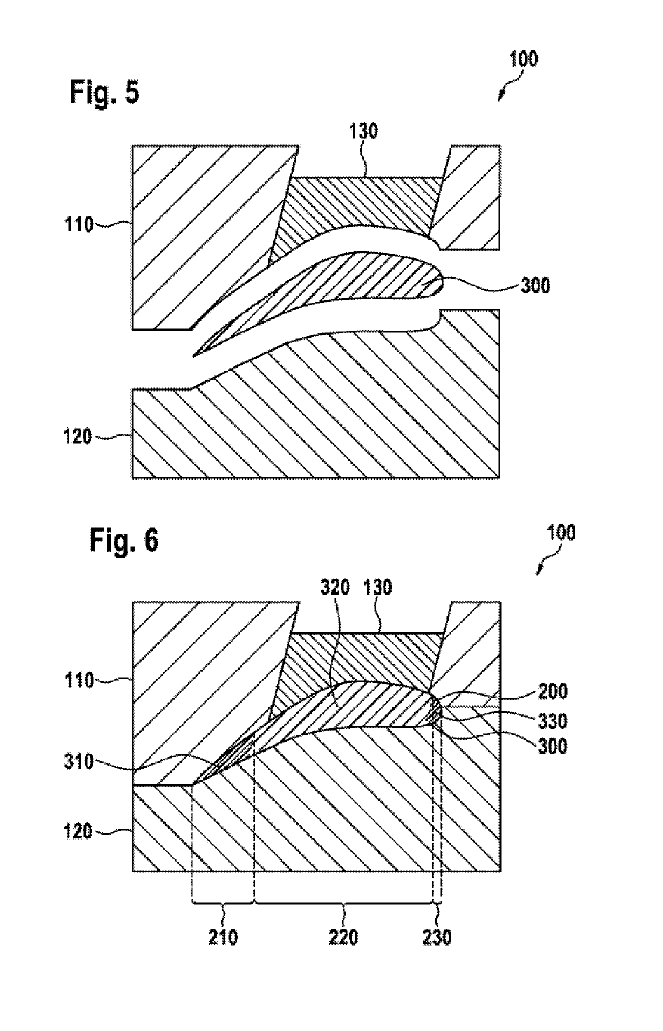

However, it is also possible, by means of the method according to the invention, to produce components with non-homogeneous foaming. By controlling the pressure, temperature and/or the speed of the expansion stroke, the morphology of the foam structure formed can be selectively influenced. In certain sections of the component 300, regions with higher degrees of foaming can be produced selectively. Non-homogeneous degrees of foaming in the component 300 can also be achieved by a further addition of the filling material 101 during the expansion stroke, by modifying the composition of the filling material during the injection phase or by other suitable measures for influencing the foaming process. FIG. 6 shows an alternative embodiment of the method according to the invention shown in FIGS. 1 to 5, in which foaming limited substantially to the central section 300 of the component has been produced by means of the expansion stroke of the sliding element 130. As shown in this figure, both the left hand, thin-walled edge section 310, which is arranged toward the bottom in the first section 110 of the cavity 200, and the thick-walled, right hand edge section 330 of the fan blade 300, which is arranged in the third section 230 of the cavity 200, have a higher density than the central component section 330, which is arranged in the second section 220 of the cavity 200. This may be desirable for reasons of strength in the case of a fan blade.

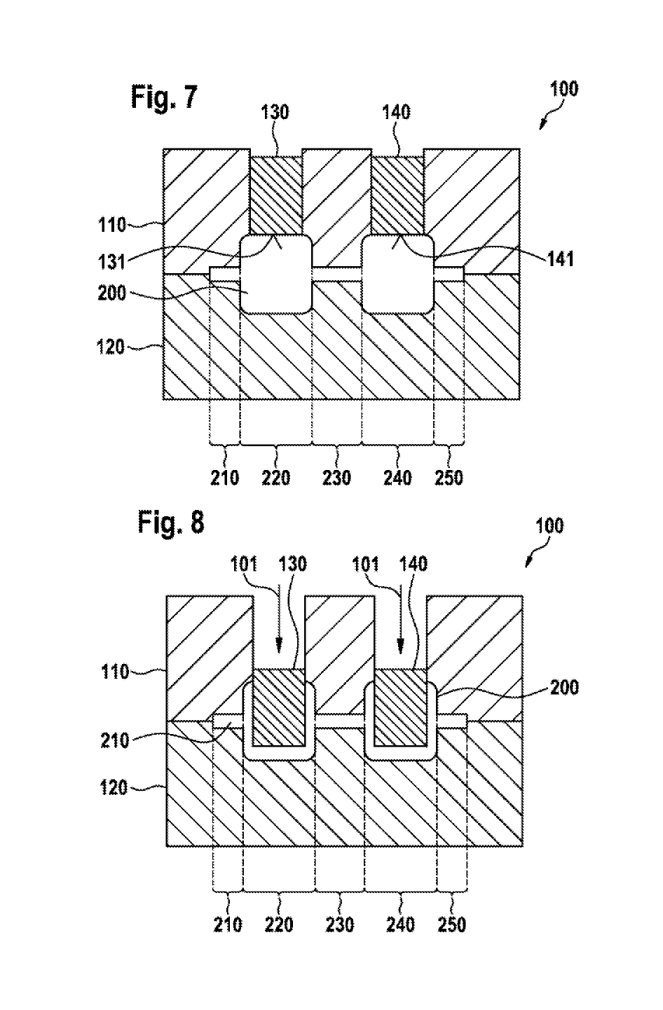

The production of a more complex component having alternate thin- and thick-walled sections 330, with the aid of a mold having two separate expansion mechanisms, is shown below. The mold shown in FIG. 7 likewise comprises two shell parts 110, 120, which are joined together and enclose an inner cavity 200. In the sectional representation shown here, the cavity 200 which defines the shape of the component to be produced comprises five sections 210 to 250, each with alternating wall thicknesses. A first section 210 of reduced depth is adjoined by a second section 220 of significantly greater depth. The second section 220 is followed by a third section 230 of lesser depth, which is adjoined by a fourth section 240 with a relatively great vertical extent. Finally, there follows a fifth section 250, likewise with a shallow depth. In the illustrative embodiment under consideration, the component structures produced in the two deep sections 220, 240 are to be produced with a greater degree of foaming than the component structures produced in the shallow sections 210, 230, 250. In order to achieve this, two sliding elements 130, 140, each limited laterally to a thick cavity section 220, 240, are used, with the result that the expansion stroke is locally limited exclusively to the two cavity regions 220, 240 that are to be foamed. As shown in FIG. 7, the correspondingly shaped lower region 131, 141 of a sliding element 130, 140 forms an upper boundary of the respectively associated cavity section 220, 240.

As already explained in conjunction with the illustrative embodiment of the method according to the invention described in FIGS. 1 to 5, the sliding elements 130, 140, which are of piston-shaped design for example, are preferably plunged into the corresponding cavity sections 220, 240 even before the injection of the filling compound in order to reduce the volume of the cavity in these sections by a defined amount. The plunge depth of the sliding elements 130, 140 determines the displaced volume of the cavity and therefore forms an important parameter for influencing the degree of foaming of the component.

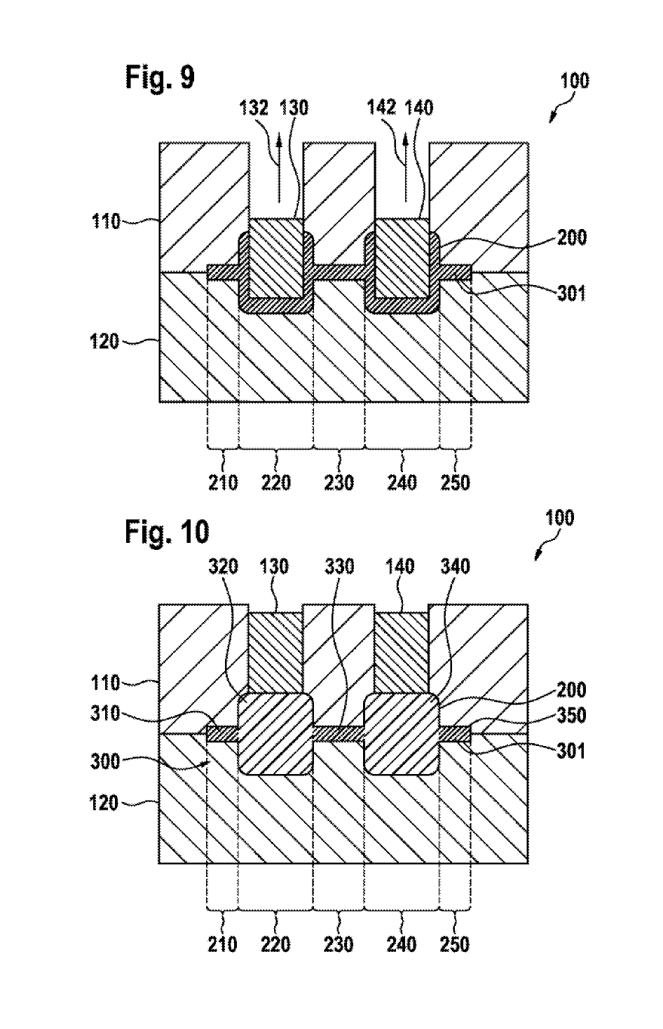

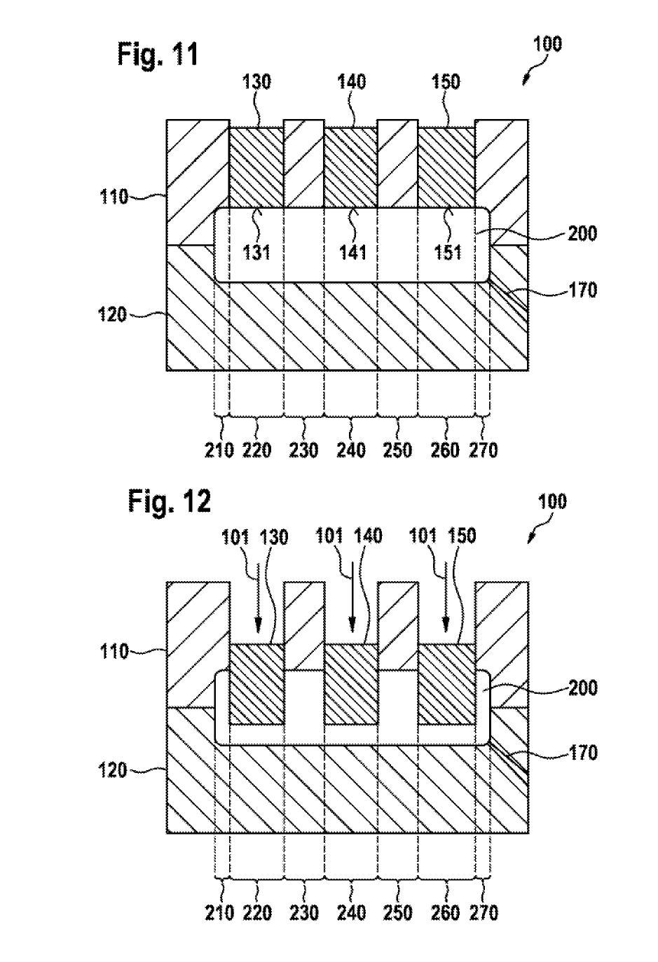

As shown in FIG. 9, a free-flowing filling compound 301 is then injected into the cavity 200 of reduced spatial volume. This is generally accomplished by at least one injection channel, although the latter is not shown here. After injection or, alternatively, even during the injection process, the piston-shaped sliding elements 130, 140 perform an expansion stroke 132, 142, by means of which the filling compound 301 is foamed. The degree of foaming in the various cavity sections 210 to 250 can be selectively determined by controlling various parameters. Thus, by controlling the speed of the expansion stroke, the temperature in the various cavity sections 210 to 250 and/or by varying the feeding of the filling compound 301 during the expansion stroke, for example, it is possible to ensure that the degree of foaming in the thin-walled cavity regions 210, 230, 250 is less than in the thick-walled cavity regions 220, 240.

FIG. 10 shows the mold 100 with the fully finished component 300. As shown here, the filling compound 301 has been foamed by the expansion stroke 132, 142 of the two sliding elements 130, 140 only in the two thick-walled cavity regions 220, 240. In the thin-walled cavity regions 210, 230, 250, in contrast, only a slight degree of foaming of the filling compound 301 or no foaming of the filling compound 301 has been achieved through selective prevention of foaming. Consequently, even complicated components with sections 310-350 of different densities can be produced with the aid of the method according to the invention.

The production of an integral injection molding with a substantially gradual degree of foaming using a mold comprising three different sliding elements is explained below. In the illustrative embodiment under consideration, the injection mold 100 likewise comprises two shell parts 110, 120, which are joined together, forming an inner cavity 200. In the example under consideration, the three sliding elements 130, 140, 150 are arranged in the upper mold shell 110 although, in principle, they can also be distributed between both shell parts 110, 120. The sliding elements 130, 140, 150 divide the cavity 200 into a total of seven sections 210, 220, 230, 240, 250, 260, 270. By way of example, an injection channel 170 is furthermore shown, opening into the seventh cavity section 270.

In the first method step, the piston-shaped sliding elements 130, 140, 150 are introduced into the cavity 200, it being possible to achieve this by a stroke motion 101 of the sliding elements when the mold shells 110, 120 are assembled. As shown in FIG. 12, the sliding elements 130, 140, 150 plunge into the cavity 200 to a predetermined depth. As an alternative, the sliding elements 130, 140, 150 can be retracted in a corresponding manner even before the shell parts 110, 120 are assembled, with the result that a reduced volume of the cavity is produced merely by joining the shell parts together.

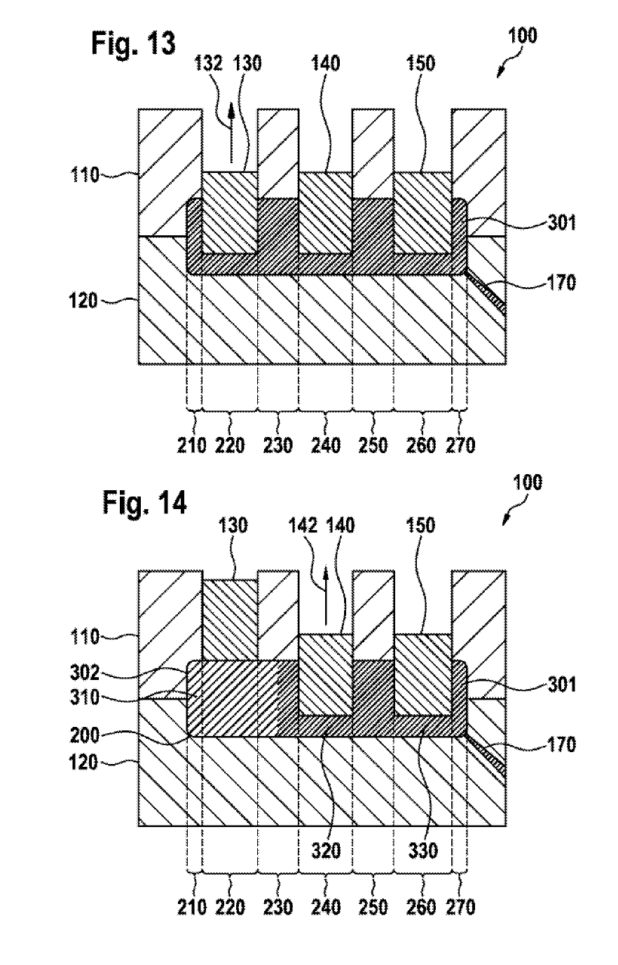

In the following method step, the filling compound 301 is injected into the cavity 200 via the injection channel 170. As shown in FIG. 13, the filling compound completely fills the cavity 200 of reduced spatial volume. As indicated by an arrow, a controlled expansion stroke 132 of the first sliding element 130 is then performed, during which the filling compound 301 is foamed, preferably only in the immediate vicinity of the first sliding elements 130. As illustrated schematically in FIG. 14, the first third of the preform 302 formed by sections 210, 220 and part of section 230 has a higher degree of foaming than the remainder after the expansion stroke 132 of the first sliding element 130. In order to produce a gradual degree of foaming with a density increasing from the left to the right, the second sliding element 140 is then retracted in a controlled manner. By means of the expansion stroke 142 of the second sliding element 140, which is indicated by means of an arrow in FIG. 14, the filling compound is foamed predominantly in the immediate vicinity of the second sliding element 140. By controlling the foaming (e.g. by temperature control), however, it is possible to ensure that the already foamed filling compound 301 in the first section of the injection molding 310 is also subject to further foaming in this method step. This ensures that the resulting degree of foaming in the first component section 310 is greater overall than in the second component section 320.

Finally, local foaming of the filling material 301 is achieved by retracting the third sliding element 150 in the third component section too. Here, the process can be controlled in such a way that the already foamed filling compound 301 in the first two component sections 310, 320 is also subject to further foaming due to the expansion stroke 150 of the third sliding element 150, which is indicated by means of an arrow 152, leading to a gradually decreasing degree of foaming of the filling compound 301 from the left to the right.

FIG. 16 shows the finished component 300 still in the mold 100 after the retraction of the third sliding element 150. As is indicated by means of different hatching, the degree of foaming of the component 300 decreases from the left to the right, with the density increasing inversely from the left to the right. Depending on the use, a substantially uniform density characteristic in the component 300 can be achieved through selective control of the method. Although the piston-shaped sliding elements 130, 140, 150 shown here have substantially the same diameter and plunge depths, the foaming process can be configured in any desired manner by using different sliding elements and/or plunge depths. Thus, with the aid of sliding elements with different base areas and/or by means of different plunge depths of the sliding elements into the cavity 200, locally different degrees of foaming can be achieved.

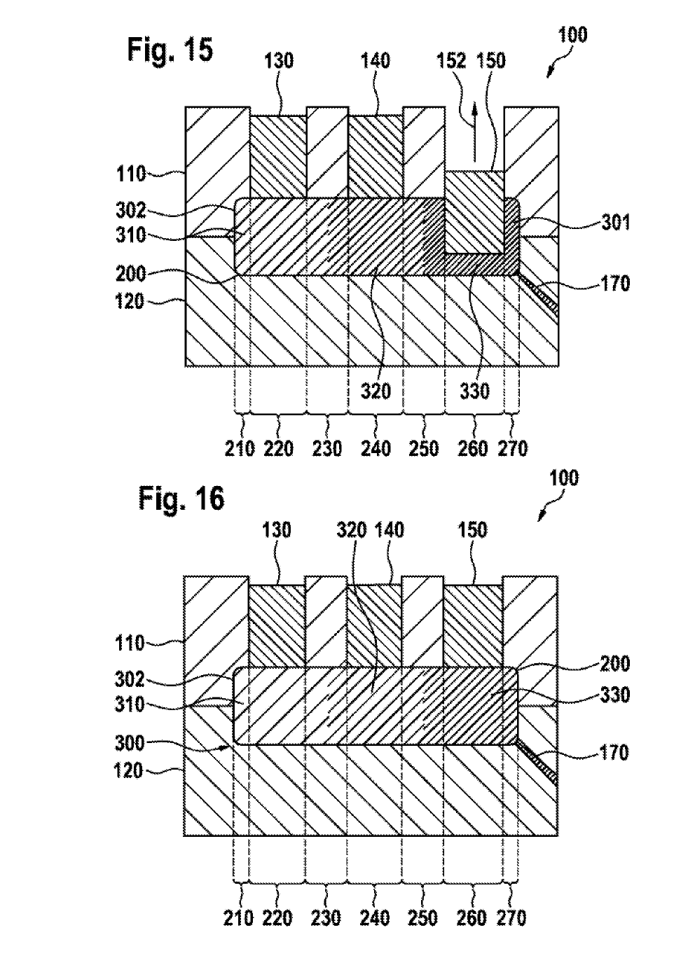

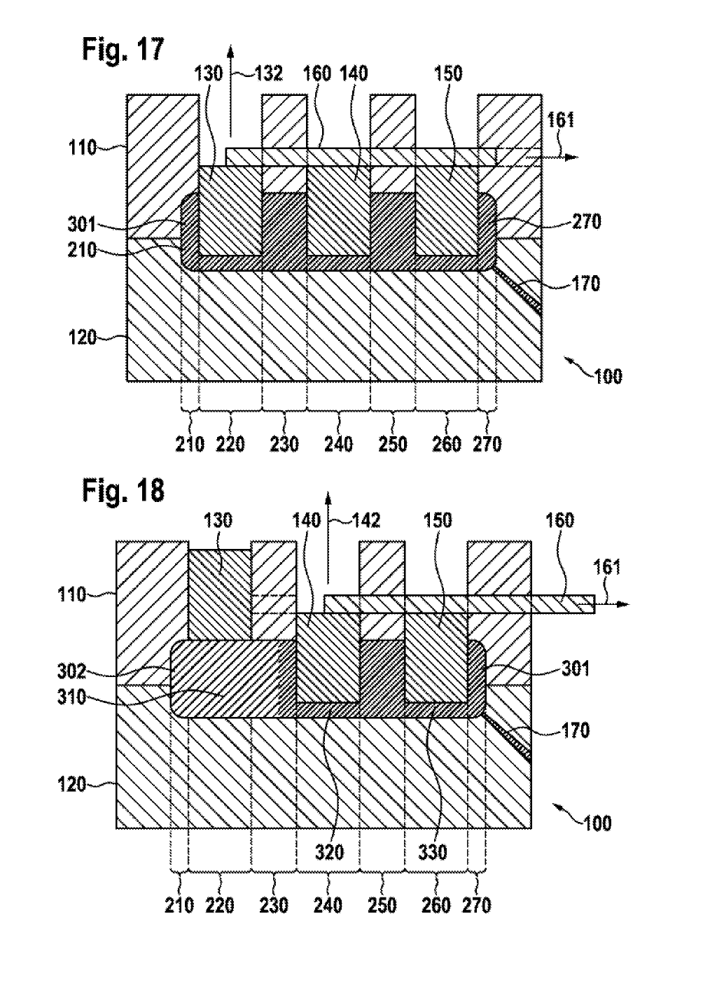

In the method according to the invention, the expansion stroke of the sliding elements can be accomplished either actively by means of corresponding driving devices, passively by means of a pressure produced by a blowing agent added to the filling material or by a combination of both methods. In the case of a passively accomplished expansion stroke, a locking mechanism, which initially blocks the movement of the sliding element, can be used to release the appropriate sliding element at the desired time. The method shown in FIGS. 17 and 18 is a modification of the production method according to the invention shown in FIGS. 13 to 16. Here, the time delay between the expansion strokes of the individual sliding elements 130, 140, 160 is brought about by means of a single locking mechanism 160. As shown in FIG. 17, the locking mechanism 160 is designed as a locking bar which is arranged so as to be movable within the first mold half 110 transversely to the direction of movement of the sliding elements 130, 140, 150. Through controlled movement of the locking bar 160 in the unlocking direction 161, the first sliding element 130 is first of all released. Owing to the pressure prevailing in the cavity 200, the first sliding element is pushed out of the cavity 200 up to a defined end position.

As shown in FIG. 18, further movement of the locking element 160 in the unlocking direction 161 leads first of all to the release of the second sliding element 130 before, finally, the third sliding element 150 is also released.

In the case of a plurality of sliding elements, it is possible to distribute these between both mold halves. In this way, it is possible to facilitate the production of the motion elements, locking mechanisms or mold cooling systems that are required especially in the case of complex geometries.

The embodiments disclosed in conjunction with the figures in the above description are merely illustrative embodiments of the invention. Depending on the use, all the features disclosed in this context may be relevant for the implementation of the invention, either individually or in combination with one another. In particular, any suitable material of an organic or metallic nature can be used as a filling compound, and can contain fillers, reinforcing materials and additives as well. Any suitable blowing gas can be used as a blowing agent, in particular a gas physically released in the molding compound, e.g. nitrogen or carbon dioxide. It is furthermore possible to use a gas or a gas mixture which has formed due to thermal excitation owing to chemical exothermic or endothermic reactions of additives in the molding compound.

The method according to the invention can also be used to produce injection moldings in which one or more inserts are additionally introduced into the cavity and partially or completely overmolded.

In the case of the method according to the invention described in conjunction with the figures, it is also possible for the cavity to be only partially filled with a filling compound and then to be foamed with the aid of an expansion stroke. In this case, the volume available is only partially filled and the empty volume of the cavity is filled by the foaming process of the filling compound.

1. A method for producing an injection molding (300) with the aid of an injection molding device (100), wherein a filling compound (301) is injected into a cavity (200) of the injection molding device (100) and is foamed with the aid of an expansion stroke (132, 142, 152), characterized in that a displacer element (130, 140, 150) limited to a selected section (220, 240, 260) of the cavity (200) is introduced into the cavity (200), and the filling compound (301) is injected into the cavity (200) with the displacer element (130, 140, 150) arranged therein, wherein, in a subsequent expansion stroke (132, 142, 152), the displacer element (130, 140, 150) is moved out from the cavity (200) in order to foam the filling compound (301) in the selected section (220, 240, 260) of the cavity (200).

2. The method as claimed in claim 1, characterized in that the expansion stroke (132, 142, 152) of the displacer element (130, 140, 150) in the selected section (220, 240, 260) of the cavity (200) produces a higher degree of foaming of the filling compound (301) than in an adjacent section (210, 230, 250, 270) of the cavity (200).

3. The method as claimed in claim 2, characterized in that the expansion stroke (132, 142, 152) of the displacer element (130, 140, 150) produces foaming of the filling compound (301) which is limited substantially to the selected section (220, 240, 260) of the cavity (200).

4. The method as claimed in claim 2, characterized in that filling compound (301) continues to be injected into the adjacent section (210, 230, 250, 270) of the cavity (200) during the expansion stroke (132, 142, 152) of the displacer element (130, 140, 150) in order to produce a low degree of foaming in this section (210, 230, 250, 270).

5. The method as claimed in claim 1, characterized in that the expansion stroke (132, 142, 152) of the displacer element (130, 140, 150) produces a substantially uniform degree of foaming of the filling compound (301) in the entire cavity (200).

6. The method as claimed in claim 1, characterized in that the expansion stroke (132, 142, 152) of the displacer element (130, 140, 150) is limited to a thick-walled section (220, 240, 260) of the cavity (200), whereas no expansion stroke takes place in an adjacent, thin-walled section (210, 230, 250, 270) of the cavity (200).

7. The method as claimed in claim 1, characterized in that a first displacer element (130), which is limited to a first selected section (220) of the cavity (200), and a second displacer element (140, 150), which is limited to a second selected section (240, 260) of the cavity (200), are introduced into the cavity (200), wherein the filling compound (301) is injected into the cavity (200) with the displacer elements (130, 140, 150) arranged therein, and wherein the displacer elements (130, 140, 150) are moved out from the cavity (200) simultaneously or in succession during the subsequent expansion stroke (132, 142, 152) in order to foam the filling compound (301) in the selected sections (220, 240, 260) of the cavity (200).

8. The method as claimed in claim 7, characterized in that the displacer elements (130, 140, 150) are moved out from the cavity (200) in succession during the subsequent expansion stroke (132, 142, 152) in such a way that the filling compound (301) in the selected sections (220, 240, 260) of the cavity (200) is foamed to different degrees.

9. A device (100) for producing an injection molding (300), comprising a cavity (200) formed from shell parts (110, 120) of the device (100), characterized in that at least one displacer element (130, 140, 150) is provided, which is designed in such a way the displacer element can be inserted into the cavity (200) in a region limited to a selected section (220, 240, 260) of the cavity (200).

10. The device (100) as claimed in claim 9, characterized in that the displacer element (130, 140, 150) is arranged so as to be movable between at least one extended position, in which at least one part of the displacer element (130, 140, 150) is inserted into the cavity (200), and an end position in which one surface (131, 141, 151) of the displacer element (130, 140, 150) forms a boundary of the cavity (200).

11. The device (100) as claimed in claim 9, characterized in that the displacer element (130, 140, 150) is a piston that can be inserted into the cavity (200).

12. The device (100) as claimed in claim 9, characterized in that the displacer element (130, 140, 150) is integrated into one of the shell parts (110, 120).

13. The device (100) as claimed in claim 9, characterized in that the displacer element (130, 140, 150) is arranged between two shell parts (110, 120).

14. The device (100) as claimed in claim 9, characterized in that a locking mechanism (160) is provided for fixing the displacer element (130, 140, 150) in a first position thereof.

15. The device (100) as claimed in claim 14, characterized in that the locking mechanism (160) is as a locking bar element that can be moved orthogonally to an expansion stroke (132, 142, 152) of the displacer element.
